(19) United States
(12) Patent Application Publication
(10) Pub. No.: US 2006/0020522 A1
(43) Pub. Date: Jan. 26, 2006

(54) Method of conducting interactive real estate property viewing

(76) Inventor: Wyatt Barton Pratt, Wilmington, NC (US)

Correspondence Address: Wyatt B. Pratt, 4210 Crockette Road, Wilmington, NC, 28409, US

(21) Appl. No.: 10/898,661

(22) Filed: Jul. 26, 2004

(51) Int. Cl. G06Q 30/00

(52) U.S. Cl. 705/27; 705/26

(57) ABSTRACT

A method for showing real property for sale to a prospective buyer uses a camera to provide a real-time continuous visual feed sent to a prospective buyer and an audio feed between a real estate agent and prospective buyer. The camera is located on the real property and moves in response to directions from the real estate agent, who is simultaneously communicating with the prospective buyer.

### BACKGROUND OF THE INVENTION

1. Field of the Invention

The present invention relates to a method of conducting interactive real estate property viewing for non-present buyers. More particularly, the method includes a reactive real-time continuous visual feed of the property for the prospective buyer in conjunction with an audio feed between a real estate agent and that buyer.

2. Description of the Related Art

Viewing real estate as a buyer may be time consuming and expensive. Travel to a prospective property may have to occur at inconvenient times, and the necessity of multiple trips causing high travel and lodging expenses, as well as stress to the prospective buyer.

Agents may be able to identify acceptable properties for a buyer through detailed discussions, questionnaires, information sheets or other information gathering endeavors. Additionally, prospective buyers may view property listings remotely through mailings and internet sites. However, these methods do not allow a real estate agent to comprehensively answer particular questions that the prospective buyer may have without undue delays.

There is a need in the art to provide real-time viewing of real estate to a prospective buyer. The present invention addresses this and other needs.

### SUMMARY OF THE INVENTION

The present invention includes a method for showing real property for sale to a prospective buyer comprising locating a real-time camera at a subject real property, transmitting a real-time visual feed of the real property from the camera to a remotely located visual display device for viewing by the prospective buyer of the real estate, displaying the real-time visual feed on the visual display device; communicating between the prospective buyer and real estate agent over an audio transmission feed effective for the prospective buyer to ask real-time questions regarding the real property relative to the displayed real-time visual feed to the real estate agent and the real estate agent to communicate information back to the prospective buyer and, concurrently, moving the camera in real-time through the real property in response to directions from the real estate agent to address the buyer's questions.

### BRIEF DESCRIPTION OF THE DRAWING

FIG. 1 illustrates the method for showing real property for sale to a prospective buyer of the present invention.

### DETAILED DESCRIPTION OF THE PREFERRED EMBODIMENT

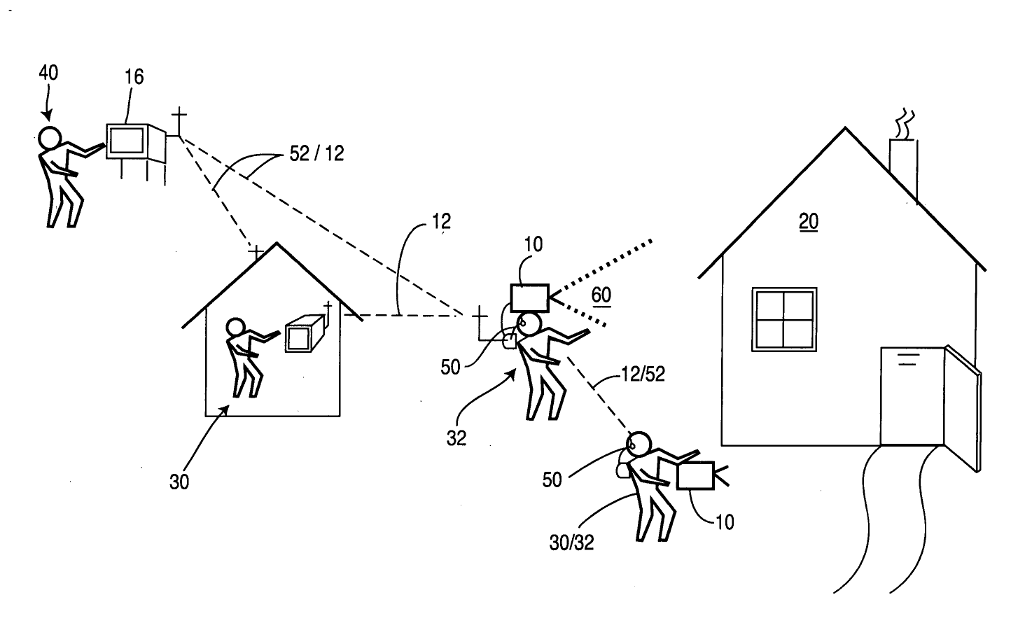

The present invention is a method for showing real property for sale (“subject real property”) to a prospective buyer without the necessity of the buyer coming to the location of the real property. As seen in FIG. 1, a real-time camera 10 that provides a continuous camera feed 12 (“continuous camera” or “visual feed”) is located on the subject real property 20 under the control of the real estate agent 30 or the real estate agent's assistant 32. The real property may be residential, commercial, or other property subject to viewing by a buyer.

Real-time cameras 10 include those cameras 10 that convert a received visual image into a signal for transmission to a remote location on an on-going basis over the time period of the operation of the camera 10, i.e., a movie-like visual scan is seen by the prospective buyer 40 rather than still singular picture-like views of the real property. Representative real-time cameras 10 include, for example, the Aiptek 6-in-1 Pocket DV Web Cam DV45000, Creative Labs Webcam for Notebooks PD 1170, Dynex PC Web Camera DX-WC 101, Logitech QuickCam for Notebooks Pro 961240-0403, etc. The real-time camera 10 provides a continuous visual feed 12 of the real property that communicates these views of the real property 20 to the prospective buyer 40 of the real estate 20, while the prospective buyer 40 is located in a remote, i.e., different, location from the real property 20. Real-time includes the direct transmission of a visual signal, allowing for normal transit times of the signal, that allows the prospective buyer 40 and real estate agent 30 to continue discussions throughout the property 20 during the viewing, with simultaneous or near-simultaneous verbal reference to the visual feed to the prospective buyer 40.

As the prospective buyer 40 views the property 20, the prospective buyer 40 and real estate agent 30 communicate through a real-time audio transmission feed 52 that allows the prospective buyer 40 to ask questions regarding the real property 20 to the real estate agent 30 and the real estate agent 30 to answer those questions and further describe the real property 20 to the prospective buyer 40. As the real estate agent 30 and prospective buyer 40 discuss different attributes of the real property 20, the real estate agent 30 moves the camera 10 to different locations and views of the real property 20 to address the buyer's questions. The audio feed 52 may be directed through an audio component of the camera 10 unit having audio capability, telephone or other audio transmission device 50, if desired.

In a preferred embodiment, the real-time camera 10 transmits the visual feed 12 over the internet or other transmission means that allow the prospective buyer 40 to readily receive the visual link. Viewing maybe on a computer, television, or other like device 16 for displaying visual images. Likewise, the audio feed 52 may occur over the internet, telephone communication or other means 50 appropriate for the real estate agent 30 to field questions from the prospective buyer 40 and direct the continuous camera 30 in response to those questions and/or comments.

Movement of the camera 10 may include a zoom-in capability 60 for enlarging particular aspects or parts of the real property 20, freeze-frame capability, assistant support of the continuous camera 10 under direction of the real estate agent 30, having the continuous camera 10 supported by the real estate agent 30, such as with the continuous camera 10 mounted on, or controlled in relation to, the real estate agent's head, or other such arrangements suitable for moving the camera 10 at the real estate agent's directions. In one embodiment, the real-time continuous camera feed is viewable by the real estate agent 30 as the agent 30 speaks to the prospective buyer 40, such as through a side camera viewing screen. Additionally, the continuous camera 12 may include multiple camera unit inputs, preferably with each unit controlled by assistants under the direction of the real estate agent 30 who may control and/or screen the visual feed between the different units during transmission for the prospective buyer 40. Once viewed, the real property 20 is known to the prospective buyer 40 for consideration to be purchased.

### EXAMPLE 1

### Prophetic

A manager of a large company is being relocated from Seattle, Wash. to Norfolk, Va. in six months. The manager contacts a real estate agent in Norfolk, Va. and discusses with the real estate agent the house size, yard size, and style of house wanted in Norfolk, Va. The manager logs onto her computer, and downloads software to receive a video and audio feed from the real estate agent. Three days later, the real estate agent schedules four 30-minute conferences with the manager, with 30 minute time period in-between each conference. The real estate agent travels to a first real property prior to the first conference with a real-time camera. The manager uses her computer to enter into the audio and visual feed from the real estate agent.

Once the manager has entered the audio and visual feed from the camera located at the property, the real estate agent proceeds to “walk the property” using the visual feed while talking with the prospective buyer over the audio feed. Simultaneously to the real estate agent using the camera to provide a visual feed from the property to the manager's computer screen, the real estate agent discusses the property, allowing both the visual and audio feed to compliment each other in describing the real property tot he manager. As the manager questions the real estate agent about the property such as the location of the door leading into the kitchen, the real estate agent steps back for the continuous camera to get a wide view of the kitchen door and explains to the manager through the audio feed about the flow patterns within the kitchen. As the real estate agent begins to travel into one of the bedrooms, the manager asks about the access into the kitchen from the living room, and the real estate agent back-tracks through the kitchen with the continuous camera to show the prospective buyer access on the other side of the kitchen. The camera is used to zoom in on the window treatments in the living room. After 25 minutes, the manager is not impressed with the house, says bye to the real estate agent and logs off of the computer. The real estate agent travels to the second house and, at the appointed time, the manager enters into the audio and visual feed from the agent a second time to view the second house. This is repeated for the subsequent houses.

### EXAMPLE 2

### Prophetic

The method of example 1, where the manager enters a website to access the audio and visual feed from the real estate agent.

### EXAMPLE 3

### Prophetic

The method of example 1, where the audio feed occurs through a telephone line.

### EXAMPLE 4

### Prophetic

The method of example 1, where the real estate agent has two camera units controlled by two assistants. As the assistants “walk the property”, in addition to being sent to the manager, the visual feed from the camera units are sent to the real estate agent at a second computer in her office with each camera feed view being numbered and showing on both computers. As the real estate agent and manager discuss the individual views of the real property, either the manager or real estate agent can enlarge individual visual feeds on the separate computer screens. Additionally, the real estate agent is in radio communication with the assistants to direct the assistants where to move their camera.

### EXAMPLE 5

### Prophetic

The method of example 4 using four assistants with four separate cameras and visual feeds.

The foregoing summary, description, examples and drawings of the invention are not intended to be limiting, but are only exemplary of the inventive features which are defined in the claims.

What is claimed is:

1. A method for showing real property for sale to a prospective buyer, comprising:
locating a real-time camera at a subject real property;
transmitting a real-time visual feed of the real property from the camera to a remotely located visual display device for viewing by the prospective buyer of the real estate;
displaying the real-time visual feed on the visual display device;
communicating between the prospective buyer and real estate agent over an audio transmission feed effective for the prospective buyer to ask real-time questions regarding the real property relative to the displayed real-time visual feed to the real estate agent and the real estate agent to communicate information back to the prospective buyer; and,
concurrently, moving the camera in real-time through the real property in response to directions from the real estate agent to address the buyer's questions.

2. The method of claim 1, wherein the communication of the real-time continuous camera to the prospective buyer passes through the internet.

3. The method of claim 1, wherein the communication between the prospective buyer and real estate agent passes through the internet.

4. The method of claim 1, wherein the continuous camera zooms in on particular parts of the real property.

5. The method of claim 1, wherein the continuous camera is supported by the real estate agent.

6. The method of claim 1, wherein the continuous camera is mounted on the real estate agent's head.

7. The method of claim 1, wherein the real-time continuous camera feed is viewable by the real estate agent.

8. The method of claim 1, wherein the continuous camera includes multiple camera units.

9. The method of claim 8, wherein the multiple camera units transmit a separate visual feeds to a screening location for selection by the real estate agent or prospective buyer.

10. The method of claim 1, wherein the real-time continuous audio feed is communicated through the continuous camera.

11. The method of claim 1, wherein the display device is selected from the group consisting of computer monitor and television.

12. The method of claim 11, wherein the display device is a computer monitor.

13. The method of claim 1, wherein the real property is residential property.

14. The method of claim 1, wherein the real property is commercial property.

15. A viewed real property product produced by the method of claim 1.
